(19) United States
(12) Patent Application Publication
(10) Pub. No.: US 2003/0160901 A1
(43) Pub. Date: Aug. 28, 2003

(54) Inverse gamma correction circuit using piecewise-linear approximation

(76) Inventor: Robert Joseph Topper, Hatboro, PA (US)

Correspondence Address: RATNERPRESTIA, P O BOX 980, VALLEY FORGE, PA, 19482-0980, US

(21) Appl. No.: 10/087,644

(22) Filed: Feb. 28, 2002

(51) Int. Cl. H04N 5/202

(52) U.S. Cl. 348/674

(57) ABSTRACT

The invention includes a circuit for applying a transfer function to correct values of an input signal. The transfer function is approximated by piecewise-linear segments generated by a plurality of segment operators. An input line in the circuit receives the input signal. Window detectors determine a value of the input signal, and select one of the segment operators based on the value of the input signal. The selected segment operator applies a correction value to correct the value of the input signal. Each of the segment operators generates a different linear segment of the piecewise-linear segments. Each of the segment operators simultaneously generates a respective correction value responsive to the value of the input signal. In one embodiment, a multiplexer selects one of the respective correction values to correct the value of the input signal.

### TECHNICAL FIELD

The present invention relates, in general, to gamma correction of video intensity values and, more specifically, to an inverse gamma correction circuit that uses piecewise-linear approximation.

### BACKGROUND OF THE INVENTION

Gamma correction is intended to create visual color match, under conditions of equal color temperature and luminance, between an original scene and its reproduction on a color picture tube, or to achieve linear light transmissivity in a liquid crystal device (LCD) display. Since the phosphors in a conventional picture tube and liquid crystal material of a LCD do not respond linearly to different voltage levels, gamma correction is performed by applying a non-linear transfer function to different voltage levels of the video signal. The compensation of brightness intensity to produce a linear gradation of brightness intensity is known as gamma correction. A conversion circuit is included in most television cameras and displays to provide the linear gradation to the brightness intensity. This conversion circuit is known as a gamma correction circuit.

Gamma correction circuits are known in the art. One such circuit performs gamma correction on a digitized intensity signal by translating each of n-bit red, green, and blue (RGB) brightness intensity values to corresponding compensated n-bit brightness intensity values using a lookup table. The lookup table is typically stored in a solid state memory, usually in a read-only memory (ROM), and includes a range of brightness intensity values, each of which is associated with a corresponding gamma corrected value. ROM gamma correction tables, however, may be slow and may require several computer cycles to implement. Gamma correction may also be accomplished using a random access memory (RAM) lookup table. This implementation requires a sizable block of high speed RAM, consuming resources and restricting routing in the RAM region of memory.

Gamma correction circuits have been disclosed by Robert J. Topper in U.S. Pat. No. 5,132,796 (issued Jul. 21, 1992) and U.S. Pat. No. 5,255,093 (issued Oct. 19, 1993), which are incorporated herein by reference.

Gamma correction is also implemented using a piecewise (step-by-step) linear transfer function utilizing a load resistor network. The network is interconnected with diodes to provide a plurality of break points at particular predetermined voltage values. A gain/voltage characteristic curve is generated, and various points on the curve are selected to compensate for nonlinear gradations of the camera or monitor. While this yields an acceptable gamma correction curve, it does not operate effectively when used in a system requiring matching of several channels. For example, it does not operate effectively in a color television channel having red, green and blue channels. In addition, analog circuits of this type are not easily integrated with digital signal processing circuits.

Another problem of a load resistor network is resolution, which is limited by the number of resistors available in the circuit. Temperature and age also affect the components of the load resistor network, resulting in characteristics that do not remain constant.

### SUMMARY OF THE INVENTION

To meet this and other needs, and in view of its purposes, the present invention provides a circuit for applying a transfer function to correct values of an input signal. The transfer function is approximated by piecewise-linear segments generated by a plurality of segment operators. An input line in the circuit receives the input signal. Window detectors determine a value of the input signal, and select one of the segment operators based on the value of the input signal. The selected segment operator applies a correction value to correct the value of the input signal.

In one embodiment, each of the segment operators generates a different linear segment of the piecewise-linear segments. Each of the segment operators simultaneously generates a respective correction value responsive to the value of the input signal. In another embodiment, a multiplexer selects one of the respective correction values to correct the value of the input signal.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. Included in the drawing are the following figures:

FIG. 1 illustrates an exemplary inverse gamma correction curve that has been sectioned into several piecewise-linear segments in accordance with an embodiment of the present invention;

FIG. 2 is an exemplary block diagram of an inverse gamma correction circuit in accordance with an embodiment of the present invention which uses N-piecewise-linear segments for the gamma correction curve;

FIG. 3 is an exemplary block diagram of another inverse gamma correction circuit in accordance with an embodiment of the present invention which uses, as an example, four piecewise-linear segments for the gamma correction curve;

FIG. 4 shows a typical amplitude error produced by an eight piecewise-linear approximation for a gamma correction curve using the exemplary circuit of FIG. 2;

FIG. 5 is an exemplary block diagram of a digital comparator that may be used in the window detectors shown in FIG. 2; and

FIG. 6 is an exemplary block diagram of yet another inverse gamma correction circuit in accordance with an embodiment of the present invention which uses AND/OR logic gates to select a video output signal.

### DETAILED DESCRIPTION OF THE INVENTION

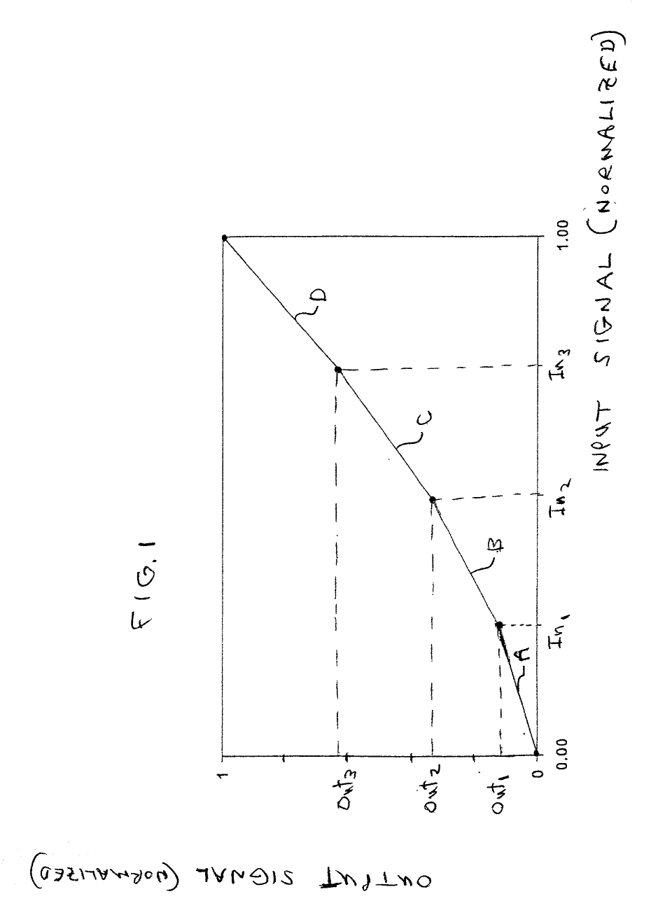

Referring to FIG. 1, there is shown an example of an inverse gamma transfer curve, which may be applied to an input video signal to produce a linear intensity scale. When sent to a video display, the corrected video signal results in an image that appears linear or smooth to the human eye. For discussion purposes, the transfer curve is a piecewise-linear approximation that includes four linear sections or segments, identified as segments A, B, C and D. In practice, more than four segments may be used.

As linear sections, segment A is defined by a line of slope (A). The slope of the line is calculated as normalized video output signal, Out₁, divided by normalized video input signal, In₁. Similarly, segment B is defined by a line of slope (B), calculated as (Out₂-Out₁)/(In₂-In₁). Segment C is similarly defined by a line of slope (C), and segment D is defined by a line of slope (D), and so on, if more segments are used.

It will be appreciated that the inverse gamma transfer curve may be approximated by piecewise-linear segments that may be of non-uniform lengths. Accordingly, the four exemplary segments illustrated in FIG. 1 are of different lengths. For example, segment D is longer than either segment A or segment B.

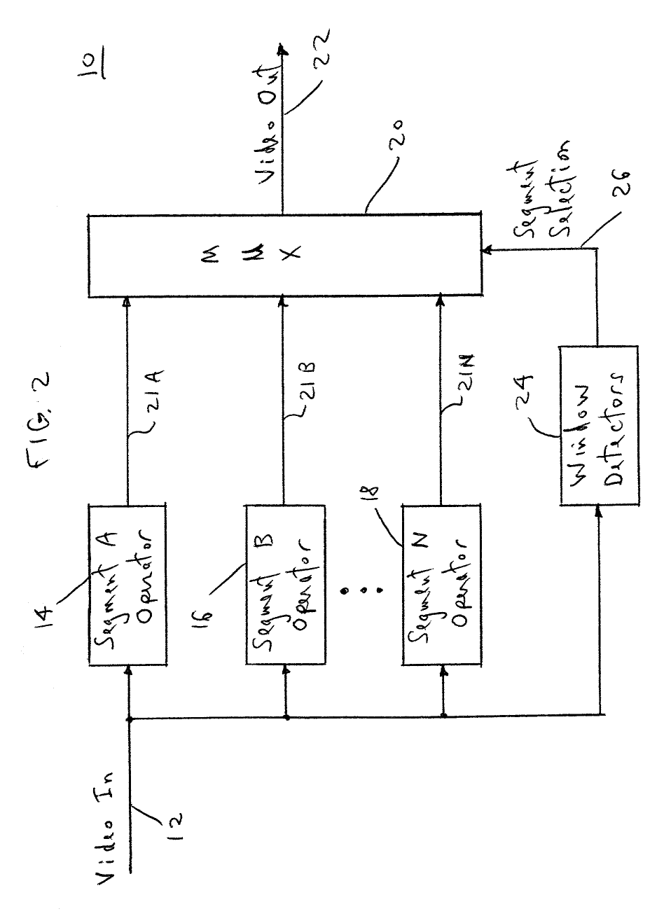

Referring to FIG. 2, there is shown inverse gamma correction circuit 10. An incoming video signal is applied via input line 12 to several segment operators of which three are shown, namely segment A operator 14, segment B operator 16 and segment N operator 18. As will be explained in greater detail, each segment operator provides an individualized linear transfer function that corrects the video input signal to produce a corrected output signal.

Each corrected output signal is coupled by way of lines 21A-21N to multiplexer 20. The multiplexer selects one of the lines to provide video output signal 22. Multiplexer 20 is controlled by segment selection line 26, which is provided from window detectors 24. As will be explained in greater detail, window detectors 24 determine which segment operator to select for correcting the video input signal.

The number of segment operators shown in FIG. 2 is N and corresponds to the number of linear segments, N, required to approximate an inverse gamma transfer curve. Because the transfer curve of FIG. 1 is approximated by four segments, for example, there are four segment operators corresponding to segments A, B, C and D.

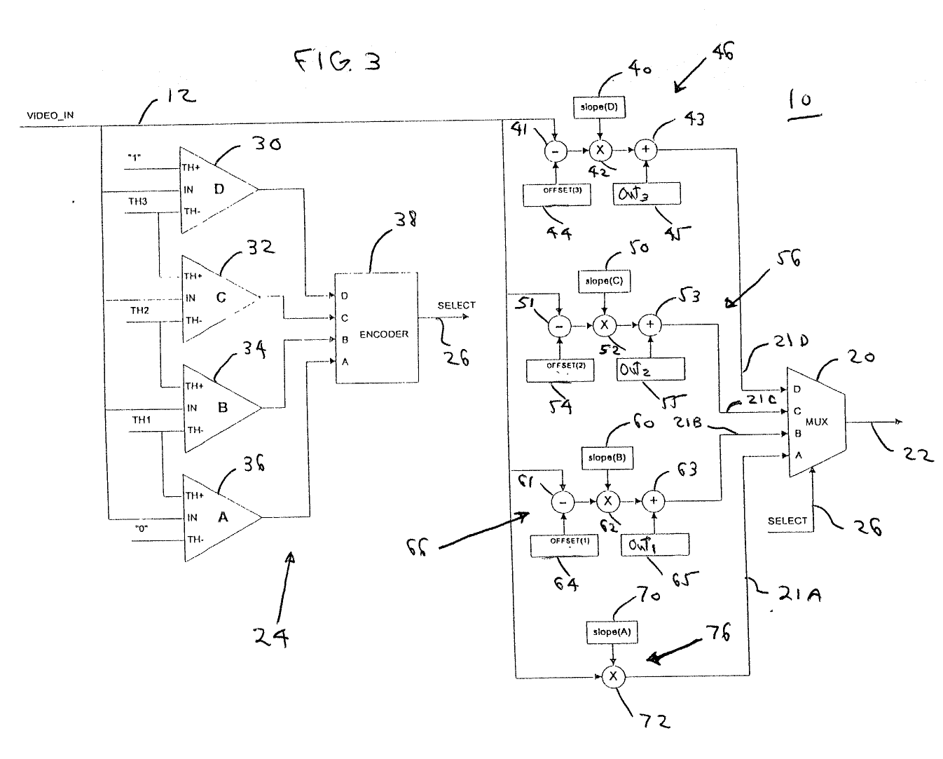

FIG. 3 is a detailed block diagram of the inverse gamma correction circuit 10. For purposes of explanation, inverse gamma correction circuit 10 includes segment operators 46, 56, 66 and 76, corresponding respectively to segments D, C, B and A of FIG. 1. Because FIG. 1 includes four linear segments approximating the inverse gamma transfer curve, gamma correction circuit 10 also includes four window detectors, namely detectors A 36, B 34, C 32 and D 30.

Window detector A 36 determines whether the value of video input 12 lies between 0.00 and In₁ (normalized value in FIG. 1). Window detector B 34 determines whether the value of video input 12 lies between In₁ and In₂. Window detector C 32 determines whether the value lies between In₂ and In₃. Finally, window detector D 30 determines whether the value lies between In₃ and 1.00.

Each window detector may be, for example, a digital comparator that includes a lower threshold value (TH−) and an upper threshold value (TH+) which are compared to the value of video input 12. Accordingly, window detector A 36 includes lower and upper threshold values of 0.00 and In₁ (normalized value), respectively. Window detector B 34 includes lower and upper threshold values of In₁ and In₂, respectively. Window detector C 32 includes lower and upper threshold values of In₂ and In₃, respectively, and window detector D 30 includes lower and upper threshold values of In₃ and 1.00, respectively.

The input video is passed through the window detectors to determine which segment operator to select for correcting the input video. As shown, each window detector includes an output line coupled to encoder 38 for generating the segment selection signal on line 26. The segment selection signal selects A, B, C, or D depending on which window detector detected the presence of an input video value between its corresponding threshold values.

Continuing the description of FIG. 3, inverse gamma correction circuit 10 includes segment operators 46, 56, 66 and 76. Except for segment operator 76, the other segment operators have similar elements. Referring first to segment operator 76, operator 76 includes multiplier 72 and storage 70 for storing a value for slope (A) of segment A. As shown, multiplier 72 multiplies the value of video input 12 with the value of slope (A). The output of multiplier 72 is coupled to multiplexer 20 by way of line 21A.

Segment operator 66 includes subtractor 61 for subtracting DC offset value 64 from video input 12. The DC offset value is subtracted from an input video value so that segment B (FIG. 1) is effectively relocated to the origin. In the example described, the DC offset value is In₁. The subtracted value is provided to one input of multiplier 62. Slope (B) from storage 60 is provided to the other input of multiplier 62. The product of multiplier 62 is provided to adder 63, along with threshold offset value 65, being a maximum output correction value of the previous segment. In the example described, the threshold offset value is Out₁. The output of segment operator 66 is coupled to multiplexer 20 by way of line 21B.

Similarly, segment operator 56 includes subtractor 51 for subtracting DC offset value 54 from video input 12. The DC offset value is subtracted from an input video value, so that segment C (FIG. 1) is effectively relocated to the origin. In the example described, the DC offset value is In₂. The subtracted value is provided to one input of multiplier 52. Slope (C) from storage 50 is provided to the other input of multiplier 52. The product of multiplier 52 is provided to adder 53, along with threshold offset value 55, being a maximum output correction value of the previous segment. In the example described, the threshold offset value is Out₂. The output of segment operator 56 is coupled to multiplexer 20 by way of line 21 C.

Finally, segment operator 46 includes subtractor 41 for subtracting DC offset value 44 from video input 12. The DC offset value is subtracted from an input video value, so that segment D (FIG. 1) is effectively relocated to the origin. In the example described, the DC offset value is In3. The subtracted value is provided to one input of multiplier 42. Slope (D) from storage 40 is provided to the other input of multiplier 42. The product of multiplier 42 is provided to adder 43, along with threshold offset value 45, being the maximum output correction value of the previous segment. In the example described, the threshold offset value is Out₃. The output of segment operator 46 is coupled to multiplexer 20 by way of line 21 D.

Multiplexer 20 passes one of the output values from segment operator 76, segment operator 66, segment operator 56 and segment operator 46 as video output 22. The select signal on line 26 is used to select the appropriate gain-adjusted signal for passage to the output.

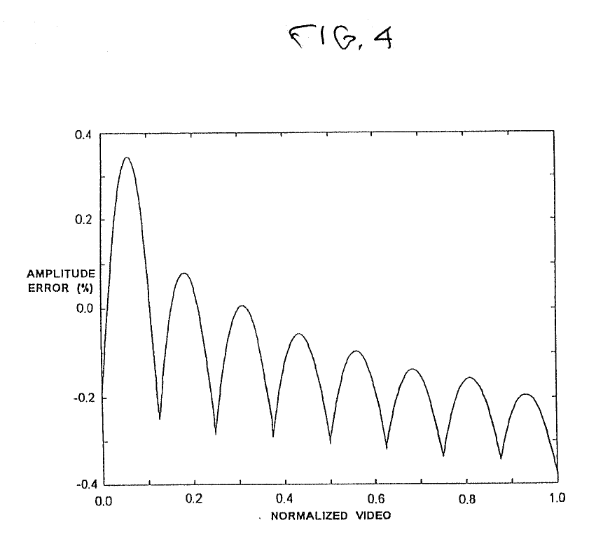

If desired, more segments may be added at the black end of the curve, where non-linearity of the curve is greater, for example, as there is no need to keep the segment lengths uniform. It will be appreciated that more segments typically use more window detectors and more segment operators. FIG. 4 illustrates the amplitude error of an eight-segment piecewise linear approximation as compared to an ideal inverse gamma curve. In the example shown, the amplitude error is less than ±0.4 percent.

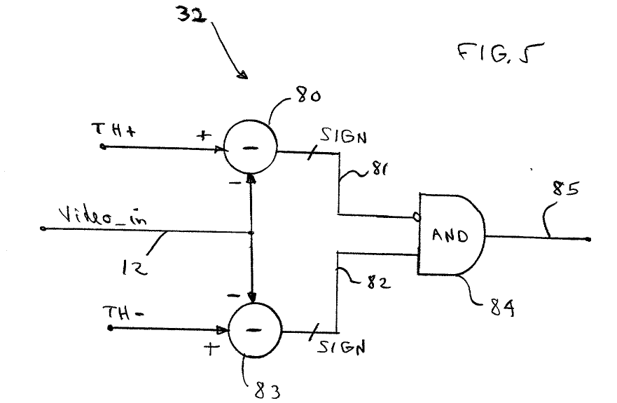

Referring next to FIG. 5, there is shown an exemplary block diagram of window detector 32, also referred to herein as digital comparator 32. Digital comparator 32 includes subtractors 80, 83 and AND-gate 85. Subtractor 80 is effective in subtracting a digital value of video-in 12 from an upper threshold value, TH+, and providing a subtracted value having a SIGN-bit on line 81 (only the SIGN-bit is shown in FIG. 5). Similarly, subtractor 83 is effective in subtracting the digital value of video-in 12 from a lower threshold value, TH−, and providing another subtracted value having a SIGN-bit on line 82.

It will be appreciated that, in the exemplary embodiment of FIG. 5, if the value of video-in 12 lies between TH+ and TH−, the SIGN-bit on line 81 may have a value of “1” (high), and the SIGN-bit on line 82 may have a value of “0” (low). With lines 81 and 82 set to “high” and “low”, respectively, AND-gate 84 may provide a “high” on output line 85, thereby indicating that window detector 32 has detected a video input value lying between the linear segment end-points of TH+ and TH−.

It will be appreciated that window detector 34 may include a digital comparator that is similar to digital comparator 32. Window detector 36, on the other hand, may omit subtractor 83, because in the exemplary transfer function of FIG. 1, TH− is assumed to be zero. In a similar manner, window detector 30 may omit subtractor 80, because in the exemplary transfer function of FIG. 1, the video input signal is assumed to have a maximum value of 1.00.

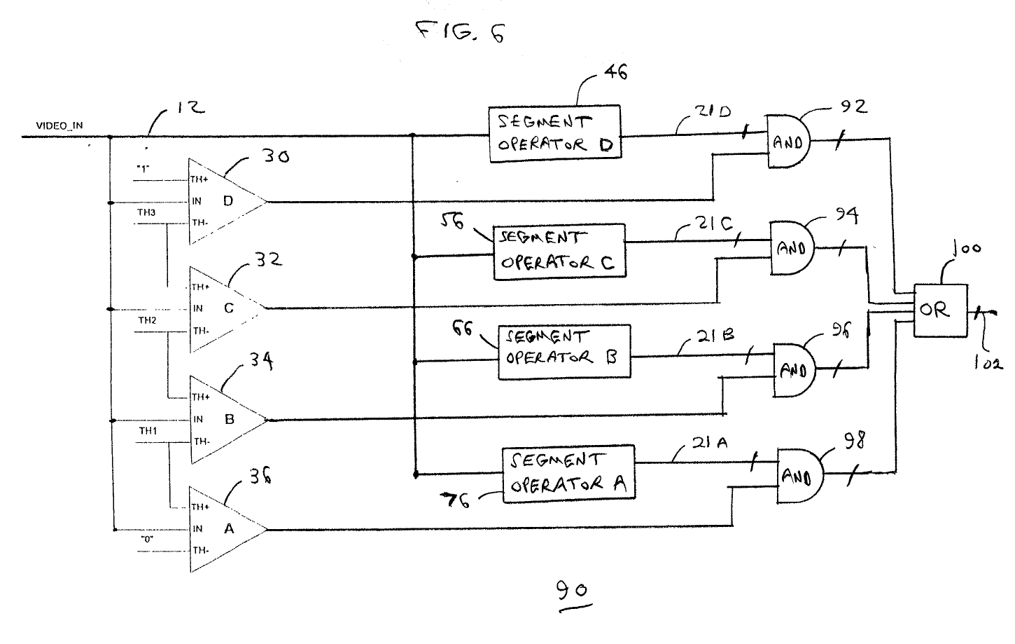

Turning next to FIG. 6, there is shown yet another embodiment of an inverse gamma correction circuit, generally designated as 90. Window detectors 30, 32, 34 and 36, as well as segment operators 46, 56, 66 and 76, may be similar to the window detectors and segment operators shown in FIG. 3. In the exemplary embodiment shown in FIG. 6, however, circuit 90 does not require encoder 38 or multiplexer 20 (FIG. 3).

Selection of a correction value on lines 21A-21D is provided by AND-gates 92, 94, 96 and 98. In operation, a correction value (N-parallel bits) on line 21D, for example, may be transferred to line 102 (N-parallel bits), after window detector 30 detects a value of video input 12 lying within its corresponding window. Upon detecting the value of video input 12, window detector 30 may enable AND-gate 92, and thereby permit passage of the correction value to line 102, by way of AND-gate 92 and OR-gate 100. In a similar manner, window detectors 32, 34 and 36 may enable AND-gate 94, AND-gate 96 and AND-gate 98, respectively. It will be appreciated that each AND-gate and the OR-gate shown in FIG. 6 includes a plurality of N-gates.

Advantageously, inverse gamma correction circuit 10 lends itself to ASIC (application specific integrated circuit) or FPGA (field programmable gate array) implementation. The subtractors, adders, multipliers, detectors, encoder and multiplexer may easily be implemented in an ASIC or an FPGA. The slopes of the individual segments may be loaded into registers. In this manner, the conventional look-up table is eliminated, thereby consuming less resource and less memory.

In an ASIC or FPGA implementation, the input video signal, shown in FIG. 3, may be a digital signal or an analog signal. If an analog signal, the input video may first be converted into a digital signal prior to being inputted to the window detectors and the segment operators.

Although illustrated and described herein with reference to certain specific embodiments, the present invention is nevertheless not intended to be limited to the details shown. Rather, various modifications may be made in the details within the scope and range of equivalents of the claims and without departing from the invention. For example, the embodiment described herein may be used to approximate other transfer functions by piecewise-linear approximation. For example, digital-to-analog converters (DACs) may use the circuit of the present invention to implement a transfer function to correct for temperature variations inherent in DACs. Any device requiring correction through a transfer function may use the present invention.

As another alternative, each of the segment operators 46, 56, 66 and 76 may be provided with a three-state output buffer (high, low and high impedance) (not shown) and the output signal of the respective window detector 30, 32, 34 and 36 may be applied as a control signal to the respective segment operator. The output ports of the segment operators 45, 56, 66 and 76 may then be combined in a wired-OR configuration. In this alternative embodiment, the AND-gates 92, 94, 96 and 98 and the OR-gates 100 may not be used.

What is claimed:

1. A circuit for applying a transfer function to an input signal comprising:
an input line for receiving the input signal;
a plurality of operators for generating piecewise-linear segments of the transfer function; and
a window detector for determining a value of the input signal and selecting one of the operators based on the value of the input signal;
wherein the selected one of the operators applies a correction value to correct the value of the input signal.

2. The circuit of claim 1 wherein the selected operator generates the piecewise-linear segment free of a table for defining the piecewise-linear segments of the transfer function.

3. The circuit of claim 1 wherein each of the operators generates a different one of the piecewise-linear segments of the transfer function.

4. The circuit of claim 3 wherein each of the operators simultaneously generates a respective correction value responsive to the value of the input signal; and
the circuit further including a multiplexer for selecting one of the respective correction values to correct the value of the input signal.

5. The circuit of claim 4 wherein the window detector includes a plurality of digital comparators and an encoder for selecting the one respective correction value to correct the value of the input signal.

6. The circuit of claim 1 wherein the selected operator includes a multiplier for multiplying the value of the input signal with a value of a slope of the piecewise-linear segment generated by the selected operator.

7. The circuit of claim 1 wherein the selected operator includes a subtractor, a multiplier and an adder;
the subtractor subtracting a lower value of the piecewise-linear segment, generated by the selected operator, from the value of the input signal to provide an offset value;
the multiplier multiplying the offset value with a value of a slope of the piecewise-linear segment to provide a product; and
the adder adding the product and a low output value of the piecewise-linear segment to provide the correction value.

8. The circuit of claim 1 wherein the input signal is a video signal and the transfer function is an inverse gamma transfer function.

9. A gamma correction circuit for applying an inverse gamma transfer function to an input video signal, the circuit comprising:
an input line for receiving the input video signal;
a plurality of operators for generating piecewise-linear segments of the inverse gamma transfer function; and
a window detector for determining a value of the input video signal and selecting one of the operators based on the value of the input video signal;
wherein the selected one of the operators applies a correction value to correct the value of the input video signal.

10. The circuit of claim 9 wherein the selected operator generates the piecewise-linear segment free of a table for defining the piecewise-linear segments of the inverse gamma transfer function.

11. The circuit of claim 9 wherein each of the operators generates a respectively different one of the piecewise-linear segments of the inverse gamma transfer function.

12. The circuit of claim 11 wherein each of the operators simultaneously generates a respective correction value responsive to the value of the input signal; and
the circuit further including a multiplexer for selecting one of the respective correction values to correct the value of the input video signal.

13. The circuit of claim 12 wherein the window detector includes a plurality of digital comparators and an encoder for selecting the one respective correction value to correct the value of the input video signal.

14. The circuit of claim 9 wherein the operator includes a multiplier for multiplying the value of the input video signal with a value of a slope of the piecewise-linear segment generated by the selected operator.

15. The circuit of claim 9 wherein the operator includes a subtractor, a multiplier and an adder;
the subtractor subtracting a lower value of the piecewise-linear segment, generated by the selected operator, from the value of the input video signal to provide an offset value;
the multiplier multiplying the offset value with a value of a slope of the piecewise-linear segment to provide a product; and
the adder adding the product and a low output value of the piecewise-linear segment to provide the correction value.
